(19) United States
(12) Patent Application Publication
(10) Pub. No.: US 2026/0067984 A1
(43) Pub. Date: Mar. 5, 2026

(54) ENHANCED RADIO RESOURCE CONTROL CONNECTION RELEASE MANAGEMENT

(71) Applicant: GOOGLE LLC, Mountain View, CA (US)

(72) Inventors: Poying Chuang, Taipei (TW); Qin Zhang, Fremont, CA (US); Tai-Lun Lo, Taipei (TW); Shang-Ru Mo, Taipei (TW); Huaiya Chen, Hsinchu County (TW); Yi-Jie Pan, New Taipei City (TW)

(21) Appl. No.: 19/014,123

(22) Filed: Jan. 8, 2025

Related U.S. Application Data
(60) Provisional application No. 63/689,486, filed on Aug. 30, 2024.

(51) Int. Cl. H04W 76/38; H04W 76/27

(52) U.S. Cl. CPC H04W 76/38; H04W 76/27

(57) ABSTRACT

A user equipment device in a cellular network implements one or more mechanisms to manage Radio Resource Control (RRC) connection at the UE. These one or more mechanisms include the UE detecting at least one condition of a plurality of conditions associated with an RRC connection between the UE and the cellular network. The UE maintains the RRC connection in response to the detected at least one condition.

### BACKGROUND

In wireless communication systems, such as cellular networks, ensuring efficient power management while maintaining reliable network connectivity is a fundamental objective. User equipment (UE) devices, such as smartphones, establish Radio Resource Control (RRC) connections with the network to enable various functionalities, including voice communication, data transfer, and application updates. To optimize power consumption, networks commonly employ mechanisms to release inactive RRC connections after a designated period of inactivity. This approach has proven effective in reducing unnecessary battery drain in most scenarios. Additionally, UEs can take proactive measures to release RRC connections locally, signaling the network that the connection is no longer required. This process includes initiating a Tracking Area Update (TAU) to ensure proper network alignment following the release. However, relying exclusively on data inactivity to trigger the RRC connection release may not address all operational scenarios effectively. Certain conditions and functional test cases have highlighted limitations in these mechanisms, emphasizing the need for enhanced approaches to improve the reliability of connection management.

### SUMMARY OF EMBODIMENTS

In accordance with one aspect, a method at a user equipment (UE) of a cellular network is provided. The method includes detecting at least one condition of a plurality of conditions associated with a Radio Resource Control (RRC) connection between the UE and a cellular network and maintaining the RRC connection in response to the detected at least one condition.

In at least some embodiments, maintaining the RRC connection includes re-establishing the RRC connection in response to the network releasing the RRC connection and the detected at least one condition indicating that the RRC connection is to be maintained.

In at least some embodiments, maintaining the RRC connection includes preventing an RRC release procedure at the UE in response to the detected at least one condition indicating that the RRC connection is to be maintained.

In at least some embodiments, maintaining the RRC connection includes maintaining the RRC connection in response to at least one of one or more timers or one or more counters associated with the at least one condition satisfying at least one threshold.

In at least some embodiments, detecting the at least one condition includes evaluating at least one condition associated with at least one of one or more paging messages or one or more control message transfers to determine whether the RRC connection should be maintained.

In at least some embodiments, detecting the at least one condition includes monitoring at least one of an Internet Protocol Multimedia Subsystem setup or registration status of the UE.

In at least some embodiments, detecting the at least one condition includes determining that an uplink data buffer of the UE comprises data to transfer.

In accordance with another aspect, a user equipment (UE) is provided. The UE includes one or more radio frequency (RF) modems configured to wirelessly communicate with at least one network, one or more processors coupled to the one or more RF modems, and at least one memory storing executable instructions. The executable instructions are configured to manipulate at least one of the one or more processors or the one or more RF modems to detect at least one condition of a plurality of conditions associated with a Radio Resource Control (RRC) connection between the UE and a cellular network and maintain the RRC connection in response to the detected at least one condition.

In at least some embodiments, the executable instructions are further configured to manipulate the at least one of the one or more processors or the one or more RF modems to maintain the RRC connection by re-establishing the RRC connection in response to the network releasing the RRC connection and the detected at least one condition indicating that the RRC connection is to be maintained.

In at least some embodiments, the executable instructions are further configured to manipulate the at least one of the one or more processors or the one or more RF modems to maintain the RRC connection by preventing an RRC release procedure at the UE in response to the detected at least one condition indicating that the RRC connection is to be maintained.

In at least some embodiments, the executable instructions are further configured to manipulate the at least one of the one or more processors or the one or more RF modems to maintain the RRC connection by maintaining the RRC connection in response to at least one of one or more timers or one or more counters associated with the at least one condition satisfying at least one threshold.

In at least some embodiments, the executable instructions are further configured to manipulate the at least one of the one or more processors or the one or more RF modems to detect the at least one condition by evaluating at least one condition associated with at least one of one or more paging messages or one or more control message transfers to determine whether the RRC connection should be maintained.

In at least some embodiments, the executable instructions are further configured to manipulate the at least one of the one or more processors or the one or more RF modems to detect the at least one condition by monitoring at least one of an Internet Protocol Multimedia Subsystem setup or registration status of the UE.

In at least some embodiments, the executable instructions are further configured to manipulate the at least one of the one or more processors or the one or more RF modems to detect the at least one condition by determining that an uplink data buffer of the UE comprises data to transfer.

In a further aspect, a method at a user equipment (UE) of a cellular network is provided. The method includes monitoring a plurality of conditions, including an uplink data buffer at the UE to detect whether data is pending for transmission, a paging message intended for the UE from the cellular network, and an Internet Protocol Multimedia Subsystem registration process ongoing at the UE. The method further includes maintaining an active Radio Resource Control (RRC) connection between the UE and the cellular network if at least one of the plurality of conditions is satisfied and releasing the RRC connection if none of the plurality of conditions is satisfied.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating an example wireless system employing a UE configured to proactively manage RRC connections in accordance with some embodiments.

FIG. 2 is a block diagram illustrating example configurations for RRC connection management employed by a UE of FIG. 1 in accordance with some embodiments.

FIG. 3 is a diagram illustrating an example hardware configuration of a UE of FIG. 1 in accordance with some embodiments.

FIG. 4 is a flow diagram illustrating an example method for managing RRC connections at a UE of FIG. 1 in accordance with some embodiments.

### DETAILED DESCRIPTION

In modern wireless communication systems, maintaining an efficient balance between power consumption and network connectivity is a challenge. User equipment (UE) devices, such as smartphones, establish a radio connection, known as the Radio Resource Control (RRC) connection, with the network (NW) to transmit control signals and data packets. This connection ensures that the UE can communicate effectively with the network for various tasks, including voice calls, data transmission, and application updates.

However, maintaining an active RRC connection for extended periods, particularly when it is not actively being used, can lead to significant power consumption on the UE side, commonly referred to as “battery drain”. To mitigate this, networks typically implement a mechanism to monitor data inactivity. If the connection remains idle for a predetermined period, often ranging from 10 to 20 seconds, the network may automatically release the RRC connection. This approach is effective in most cases, with studies showing that RRC connections are released after a period of inactivity in approximately 84% of instances.

Despite the effectiveness of network-initiated RRC connection releases, there are scenarios where the network may fail to release the connection, such as when the UE does not receive the connection release message. To address this, the UE can proactively release the RRC connection locally, thereby conserving battery life. When the UE initiates a local release, it triggers a Tracking Area Update (TAU) request message with the Active-Flag set to 0, signaling to the network that the RRC connection is no longer needed. Consequently, the network can proceed to release the RRC connection.

During the local release initiated by the UE, the RRC connection, which originally included both Signaling Radio Bearer (SRB) and Data Radio Bearers (DRBs), is replaced with a newly established RRC connection containing only SRB after the TAU procedure is completed. Typically, this new RRC connection is released by the network immediately following the TAU procedure via an RRC Connection Release message.

While the method of monitoring data inactivity to trigger RRC connection release is widely recognized, it may not be sufficient in all cases. Relying solely on data inactivity to justify and initiate the RRC connection release procedure can lead to issues. For instance, in lab testing, UEs relying only on data inactivity for RRC connection fail more than 100 test cases across various functional areas in different laboratories and networks. For example, failures were observed in scenarios such as missed IMS SIP (Internet Protocol Multimedia Subsystem Session Initiation Protocol) registrations, unexpected RRCConnectionRequests during Tracking Area Updates, rejected RRC connections during LPP (Long Term Evolution Positioning Protocol) procedures, and lack of response to RRCConnection requests following local releases by the UE. These examples highlight the limitations of data inactivity-based mechanisms in addressing all operational scenarios effectively.

As such, the following describes embodiments of systems and methods for managing RRC connection usage in a UE. The UE, in at least some embodiments, includes various configurations for proactively monitoring conditions beyond data inactivity to decide whether to maintain or release the RRC connection with the network. For example, in one configuration, if the network releases the RRC connection but the UE determines the connection should be maintained, the UE quickly re-establishes the connection to provide better service to upper layers and users. In another configuration, if the network does not release the RRC connection but the UE considers releasing it proactively, the UE evaluates specific conditions and refrains from triggering the release.

The conditions monitored by the UE include, for example, factors related to network support for specific services, pending data or control message transfers, network signaling activity, and the like. Based on these monitored conditions, the UE, in at least some embodiments, employs timers or counters to dynamically determine whether to maintain or release the RRC connection. This approach ensures improved service quality, power efficiency, and responsiveness for users and network interactions.

For ease of illustration, the following techniques are described in an example context in which one or more UEs and one or more RANs implement at least a Fourth Generation (4G) Long-Term Evolution (3GPP LTE) standard (e.g., 3GPP Release 8, Release 9, Release 10, etc.) or a Fifth Generation (3G) New Radio (NR) standard (e.g., 3GPP Release 13, 3GPP Release 16, 3GPP Release 17, etc.) (hereinafter, “3G NR” or “3G NR standard”). However, it should be understood that the present disclosure is not limited to networks employing an LTE or 3G NR RAT configuration, but rather, the techniques described herein can be applied to any RAT employed at the UEs, and the RANs that implement Radio Resource Management Mobility operations are an equivalent thereof. It should also be understood that the present disclosure is not limited to any specific network configurations or architectures described herein for implementing RRC management modes at UEs for relaxing RRM activities. Instead, techniques described herein can be applied to any configuration of RANs. Also, the present disclosure is not limited to the examples and context described herein, but rather, the techniques described herein can be applied to any network environment where a UE implements RRC management modes at a UE for relaxing RRM activities.

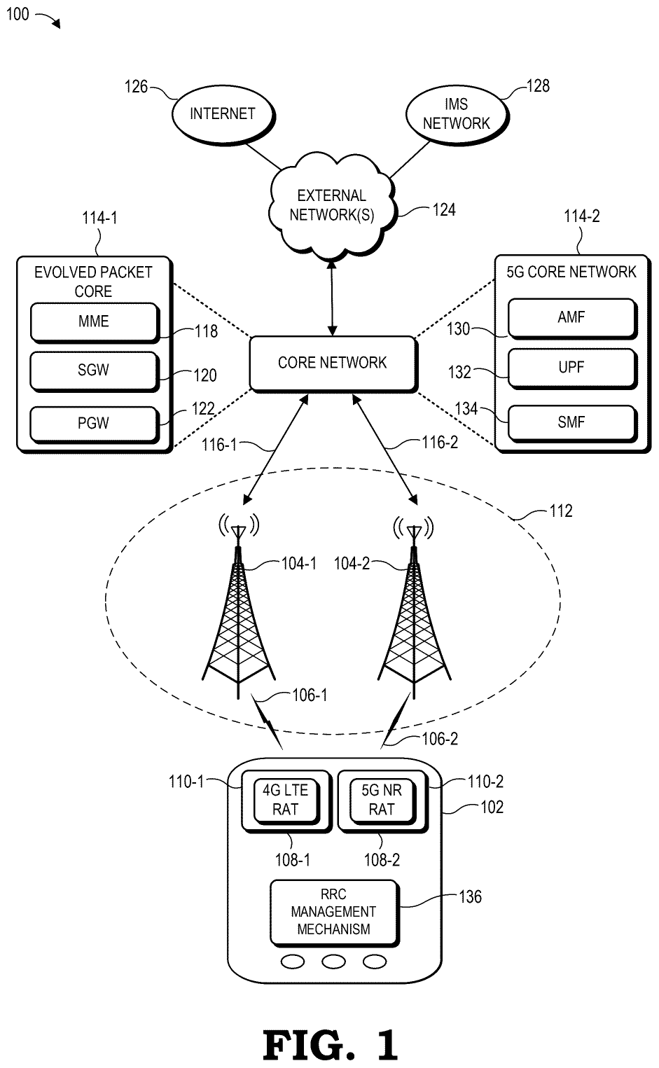

FIG. 1 illustrates a mobile cellular network 100 (also referred to here as “cellular network 100” or “network 100”) in accordance with at least some embodiments. As shown, the mobile cellular network 100 includes a device, such as a user equipment (UE) 102, that is configured to communicate with one or more base stations (BSs) 104 (illustrated as BS 104-1 and BS 104-2) through one or more wireless communication links 106 (illustrated as wireless links 106-1 and 106-2). The UE 102, in at least some embodiments, includes any of a variety of wireless communication devices, such as a cellular phone, a cellular-enabled tablet computer or cellular-enabled notebook computer, a cellular-enabled wearable device, an automobile, or other vehicle employing cellular services (e.g., for navigation, provision of entertainment services, in-vehicle mobile hotspots, etc.), and so on. In at least some embodiments, the UE 102 employs a single RAT 108. In other embodiments, the UE 102 is a multi-mode UE that employs multiple RATs 108 (illustrated as RAT 108-1 and RAT 108-2). Examples of multiple RATs include cellular-based RATs, such as a 3GPP Long-Term Evolution (3GPP LTE) RAT, a 3GPP Fifth Generation New Radio (3G NR) RAT, a WLAN RAT, and the like. It should be understood that although FIG. 1 only shows the UE 102 implementing two different RATs 108, the UE 102, in at least some implementations, implements three or more different RATs 108. In at least some embodiments, one or more RAT modules 110 (illustrated as RAT module 110-1 and RAT module 110-2) manage the RATs 108 and enable communication between the UE 102 and the radio access technology of the network 100. The one or more RAT modules 110, in at least some embodiments, include one or more of a modem chipset(s) of the UE 102, a protocol stack(s), driver software, and the like.

In at least some embodiments, the BSs 104 are implemented in a macrocell, microcell, small cell, picocell, and the like, or any combination thereof. Examples of base stations 104 include an Evolved Universal Terrestrial Radio Access Network Node B (E-UTRAN Node B), Evolved Node B (eNodeB or eNB), Next Generation (NG or NGEN) Node B (gNode B or gNB), and so on. The BSs 104 communicate with the UE 102 via the wireless links 106, which are implemented using any suitable type of wireless link. The wireless links 106, in at least some embodiments, include a downlink of data and control information communicated from the base stations 104 to the UE 102, an uplink of data and control information communicated from the UE 102 to the BSs 104, or both. In at least some embodiments, the wireless links 106 (or bearers), such as data radio bearers (DRBs) and signal radio bearers (SRBs), are implemented using any suitable communication protocol or standard, or combination of communication protocols or standards, such as 3GPP 4G LTE, 3G NR, and so on. In at least some embodiments, multiple wireless links 106 are aggregated in a carrier aggregation to provide a higher data rate for the UE 102. Also, multiple wireless links 106 from multiple BSs 104 are configured, in at least some embodiments, for coordinated multipoint (CoMP) communication with the UE 102, as well as dual connectivity, such as single-RAT LTE-LTE or NR-NR dual connectivity or multi-radio access technology (Multi-RAT) dual connectivity (MR-DC) including E-UTRA-NR dual connectivity (EN-DC), NGEN radio access network (RAN) E-UTRA-NR dual connectivity (NGEN-DC), and NR E-UTRA dual connectivity (NE-DC).

The BSs 104 collectively form a Radio Access Network (RAN) 112, such as an E-UTRAN or 3G NR RAN. The base stations 104 are connected to a core network (CN) 114 (illustrated as CN 114-1 and CN 114-2) via control-plane and user-plane interfaces through one or more links 116 (illustrated as link 116-1 and link 116-2). Depending on the configuration of the mobile cellular network 100, the core network 114 is either an Evolved Packet Core (EPC) network 114-1 or a 3G Core Network (3GC) 114-2. For example, in an E-UTRAN configuration or a 3G non-standalone (NSA) EN-DC configuration, the core network 114 is an EPC network 114-1 that includes, for example, a Mobility Management Entity (MME) 118, a Serving Gateway (SGW) 120, and a Packet Data Network Gateway (PGW) 122. The MME 118 provides control-plane functions, such as registration and authentication of multiple UEs 102, authorization, mobility management, and so on. The SGW 120 transfers user-plane packets related to audio calls, video calls, Internet traffic, and the like. The PGW 122 provides connectivity from the UE 102 to external packet data networks 124, such as the Internet 126 and an Internet Protocol Multimedia Subsystem (IMS) network 128, by being the point of exit and entry of traffic for the UE 102. In a 3G standalone (SA) configuration or an NSA NE-DC or NGEN-DC configuration, the core network 114 is a 3GC network 114-2. The 3GC 114-2 includes, for example, an Access and Mobility Management function (AMF) 130, a User Plane Function (UPF) 132, and a Session Management Function (SMF) 134. The AMF 130 provides control-plane functions such as registration and authentication of multiple UEs 102, authorization, mobility management, and so on. The UPF 132 transfers user-plane packets related to audio calls, video calls, Internet traffic, and the like. The SMF 134 manages protocol data unit (PDU) sessions.

In at least some embodiments, the core network 114 communicatively couples the UE 102 to an IMS network 128 via the RAN 112. The IMS network 128 provides various IMS services to the UE 102, such as IMS short messages, IMS unstructured supplementary service data (USSD), IMS value-added service data, IMS supplementary service data, IMS voice calls, and IMS video calls. To this end, an entity (e.g., a server or a group of servers) operating in the IMS network 128 supports packet exchange with the UE 102. The packets convey signaling (such as session initiation protocol (SIP) messages, IP messages, or other suitable messages) as well as data (or media), such as voice or video. In at least some embodiments, the IMS network includes entities (not shown) such as a Proxy Call Session Control Function (P-CSCF), an Interrogating Call Session Control Function (I-CSCF), a Serving Call Session Control Function (S-CSCF), a Home Subscriber Server (HSS), a Media Gateway Control Function (MGCF), and the like.

As described above, optimizing user experience at a UE 102 involves balancing advanced functionality with efficient power and connection management, particularly in the context of managing RRC connection usage. The dynamic and varying network conditions introduce challenges such as inefficient power consumption, unnecessary RRC connection releases, or failures to release connections when appropriate. To address these challenges, the UE 102, in one or more embodiments, employs mechanisms to monitor and adapt to various connection-related conditions. For example, the UE 102 integrates at least one proactive RRC management mechanism 136 that dynamically evaluates the need to maintain or release an RRC connection based on conditions beyond data inactivity, such as network activity, pending data transfers, service requirements, and the like. This adaptive management enables the UE 102 to optimize power consumption while ensuring seamless service continuity and improved user experience.

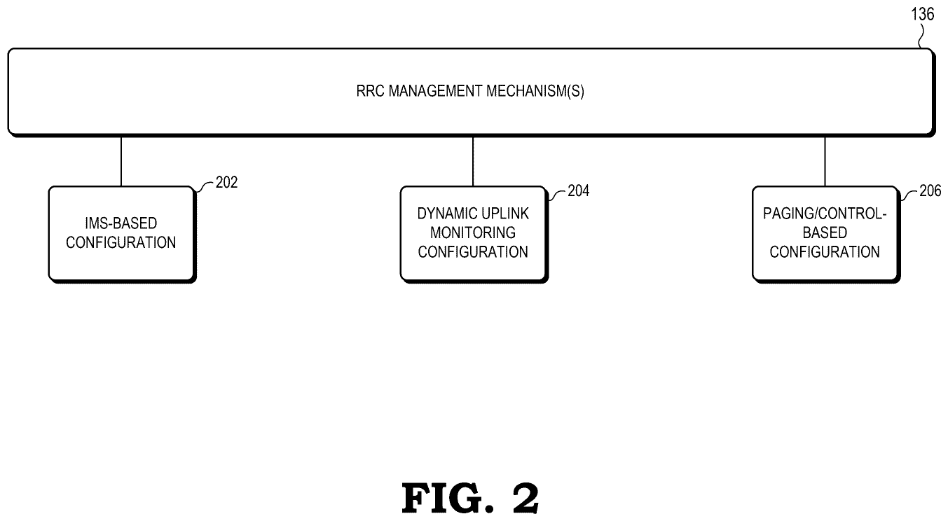

FIG. 2 illustrates various example configurations employed, individually or in combination, by the UE 102 as part of the RRC management mechanism 136 in accordance with at least some embodiments. These configurations include an IMS-based configuration 202, a dynamic uplink monitoring configuration 204, and a paging/control-based configuration 206. The RRC management mechanism 136 implements these configurations either independently or based on specific network conditions and service requirements to optimize connection usage.

In the IMS-based configuration 202, the RRC management mechanism 136 evaluates the status of IMS services to determine whether to maintain the RRC connection. For example, if the network supports IMS services but the IMS packet data network (PDN) has not yet been established, the UE 102 keeps the RRC connection active to facilitate the IMS setup process. Similarly, if IMS services are supported by the network but not yet registered on the UE 102, the mechanism ensures the RRC connection is maintained to expedite the registration process.

The dynamic uplink monitoring configuration 204 focuses on monitoring the uplink (UL) data buffer and associated data activities to determine the appropriate RRC connection state. For instance, if the uplink data from the application processor (AP) of the UE 102, such as web browsing or DNS queries, is pending, the UE 102 keeps the RRC connection active to ensure timely data transmission. Additionally, if uplink data from the modem, including Bearer Independent Protocol (BIP) or dummy packets, is queued, the mechanism 136 retains the RRC connection to facilitate efficient data handling.

In the paging/control-based configuration 206, the RRC management mechanism 136 monitors network paging and control message requirements to make decisions about RRC connection status. For example, if the UE 102 receives a paging message intended for it, the mechanism 136 keeps the RRC connection active to process the paging promptly. Similarly, if there are control messages to transfer, such as those from the non-access stratum (NAS) or access stratum (AS) layers, or from other layers, such as the long-term evolution positioning protocol (LPP), commercial mobile alert system (CMAS)/wireless emergency alerts (WEA), or SMS, the mechanism 136 ensures the RRC connection is not prematurely released, thereby maintaining effective communication.

Across these configurations, the enhanced RRC management mechanism 136, in at least some embodiments, employs timers or counters to dynamically assess whether to maintain or release the RRC connection. This adaptive approach enables the UE 102 to optimize power consumption, ensure seamless service continuity, and enhance the overall user experience, even under varying network and service conditions.

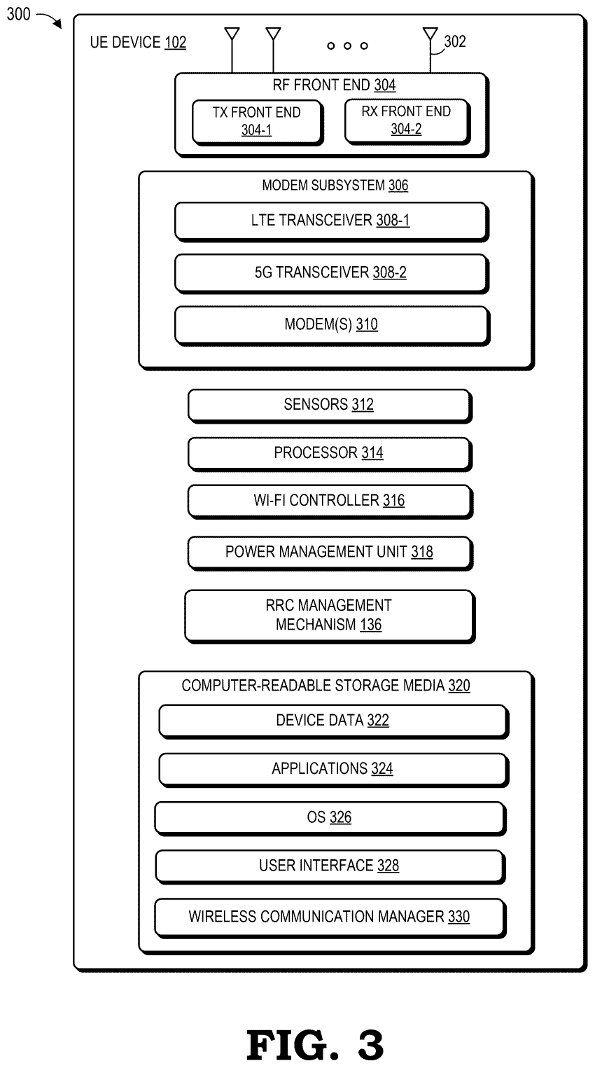

FIG. 3 illustrates an example device diagram 300 of a UE 102. In at least some embodiments, the device diagram 300 describes a UE that implements the RRC management techniques described herein. The UE 102 may include additional functions and interfaces that are omitted from FIG. 3 for the sake of clarity. The UE 102, in at least some embodiments, includes antennas 302, a radio frequency (RF) front end 304, and a modem subsystem 306. The modem subsystem 306 includes multiple transceivers 308 (e.g., a 3GPP 4G LTE transceiver 308-1 and a 3G NR transceiver 308-2) for communicating with one or more base stations 104 in a RAN 112, such as a 3G RAN, an E-UTRAN, a combination thereof, and so on. The modem subsystem 306 also includes a cellular modem 310 (also referred to as a baseband processor or a communication processor) that is responsible for managing the operations of the transceivers 308. In at least some embodiments, the modem 310 is implemented as a modem baseband processor, software-defined radio module, configurable modem (e.g., multi-mode, multi-band modem), wireless data interface, wireless modem, or so on. The modem 310 supports, for example, one or more of data access, messaging, or data-based services of a wireless network, as well as various audio-based communication (e.g., voice calls).

The RF front end 304, in at least some embodiments, includes a transmitting (Tx) front end 304-1 and a receiving (Rx) front end 304-2. The Tx front end 304-1 includes components such as one or more power amplifiers (PA), drivers, mixers, filters, and so on. The Rx front end 304-2 includes components such as low-noise amplifiers (LNAs), mixers, filters, and so on. The RF front end 304, in at least some embodiments, couples or connects the modem subsystem 306, including the LTE transceiver 308-1 and the 3G NR transceiver 308-2, to the antennas 302 to facilitate various types of wireless communication.

In at least some embodiments, the antennas 302 of the UE 102 include an array of multiple antennas configured similarly to or different from each other. The antennas 302 and the RF front end 304, in at least some embodiments, are tuned to or are tunable to one or more frequency bands, such as those defined by the 3GPP LTE, 3GPP 3G NR, IEEE Wireless Local Area Network (WLAN), IEEE Wireless Metropolitan Area Network (WMAN), or other communication standards. In at least some embodiments, the antennas 302, the RF front end 304, and the transceivers 308 are configured to support beamforming (e.g., analog, digital, or hybrid) or In-Phase and Quadrature (I/Q) operations (e.g., I/Q modulation or demodulation operations) for the transmission and reception of communications with one or more base stations 104. By way of example, the antennas 302 and the RF front end 304 operate in sub-gigahertz bands, sub-6 GHz bands, above 6 GHz bands, or a combination of these bands defined by the 3GPP LTE, 3GPP 3G NR, or other communication standards.

In at least some embodiments, the antennas 302 include one or more receiving antennas positioned in a one-dimensional shape (e.g., a line) or a two-dimensional shape (e.g., a triangle, a rectangle, or an L-shape) for implementations that include three or more receiving antenna elements. While the one-dimensional shape enables the measurement of one angular dimension (e.g., an azimuth or an elevation), the two-dimensional shape enables two angular dimensions to be measured (e.g., both azimuth and elevation). Using at least a portion of the antennas 302, the UE 102 can form beams that are steered or un-steered, wide or narrow, or shaped (e.g., as a hemisphere, cube, fan, cone, or cylinder). The one or more transmitting antennas may have an un-steered omnidirectional radiation pattern or may produce a wide steerable beam. Either of these techniques enables the UE 102 to transmit a radio signal to illuminate a large volume of space. In some embodiments, the receiving antennas generate thousands of narrow steered beams (e.g., 2000 beams, 4000 beams, or 6000 beams) with digital beamforming to achieve desired levels of angular accuracy and angular resolution.

The UE 102, in at least some embodiments, includes one or more sensors 312 implemented to detect various properties such as one or more of temperature, supplied power, power usage, battery state, or the like. Examples of sensors include a thermal sensor, a battery sensor, a power usage sensor, and so on.

The UE 102 also includes at least one processor 314. The processor 314, in at least some embodiments, is a single-core processor or a multiple-core processor composed of a variety of materials, such as silicon, polysilicon, high-K dielectric, copper, and so on. In at least some embodiments, the processor 314 is implemented at least partially in hardware, including, for example, components of an integrated circuit or a System-on-a-Chip (SoC), a Digital-Signal-Processor (DSP), an Application-Specific Integrated Circuit (ASIC), a Field-Programmable Gate Array (FPGA), a Complex Programmable Logic Device (CPLD), other implementations in silicon or other hardware, or a combination thereof. Examples of the processor(s) 314 include a communication processor if not implemented within the modem subsystem 306), an application processor, microprocessors, DSPs, controllers, and so on. An application processor, in at least some embodiments, provides computing resources to applications executing on the UE 102. For example, an application provides a self-contained operating environment that delivers system capabilities (e.g., graphics processing, memory management, and multimedia processing) to support applications executing on the UE 102.

The UE 102, in at least some embodiments, further includes a Wi-Fi controller 316, which is responsible for managing the device's connection to Wi-Fi networks. The Wi-Fi controller 316 handles tasks such as scanning for available networks, establishing and maintaining Wi-Fi connections, and managing data transmission over Wi-Fi. The UE 102 interacts with the modem subsystem 306 and other components to coordinate network access and ensure seamless switching between Wi-Fi and cellular networks. The Wi-Fi controller 316, in at least some embodiments, is implemented as an integrated circuit (IC), either part of an SoC, or as a discrete component within the UE 102.

The UE 102 further includes a power management unit (PMU) 318, which is responsible for managing power distribution across the various components of the UE 102, including the RF front end 304, the modem subsystem 306, and the modem 310. The PMU 318 optimizes power usage by adjusting the power levels supplied to different components based on their operational state, ensuring that power consumption is minimized during periods of low activity or when certain components are disabled, such as when specific RATs are deprioritized or disabled based on the RAT selection techniques described herein. The PMU 318 also manages battery charging and ensures efficient power delivery to components when needed. In at least some embodiments, the PMU 318 is implemented as an IC that is either part of an SoC or as a discrete component within the UE 102.

The UE 102 further includes a non-transitory computer-readable storage media 320 (CRM 320). The computer-readable storage media described herein excludes propagating signals. The CRM 320, in at least some embodiments, includes any suitable memory or storage device such as random-access memory (RAM), static RAM (SRAM), dynamic RAM (DRAM), non-volatile RAM (NVRAM), read-only memory (ROM), or Flash memory useable to store device data 322 of the UE 102. In at least some embodiments, the device data 322 includes user data, multimedia data, beamforming codebooks, applications 324, an operating system 326 of the UE 102, a user interface(s) 328, and so on, which are executable by the processor(s) 314 to enable user-plane communication, control-plane signaling, and user interaction with the UE 102. The user interface 328, in at least some embodiments, is configured to receive inputs from a user of the UE 102, such as to receive input from a user that defines and or facilitates one or more aspects of adverse radio link condition detection. In at least some embodiments, the user interface 328 includes a graphical user interface (GUI) that receives the input information via a touch input. In other instances, the user interface 328 includes an intelligent assistant that receives the input information via an audible input or speech. Alternatively, or additionally, the operating system 326 of the UE 102 is maintained as firmware or an application on the CRM 320 and executed by the processor(s) 314.

The CRM 320, in at least some embodiments, further includes a communication manager 330. Alternatively, or additionally, the communication manager 330, in at least some embodiments, is implemented in whole or part as hardware logic or circuitry integrated with or separate from other components of the UE 102. In at least some embodiments, the communication manager 330 configures the RF front end 304, the LTE transceiver 308-1, the 3G NR transceiver 308-2, or a combination thereof to perform one or more wireless communication operations.

The UE 102 also includes the RRC management mechanism 136 described herein. The RRC management mechanism 136, in at least some embodiments, is implemented in whole or part as hardware logic or circuitry integrated with or separate from other components of the UE 102. In other embodiments, one or more portions of the RRC management mechanism 136 are implemented in the CRM 320.

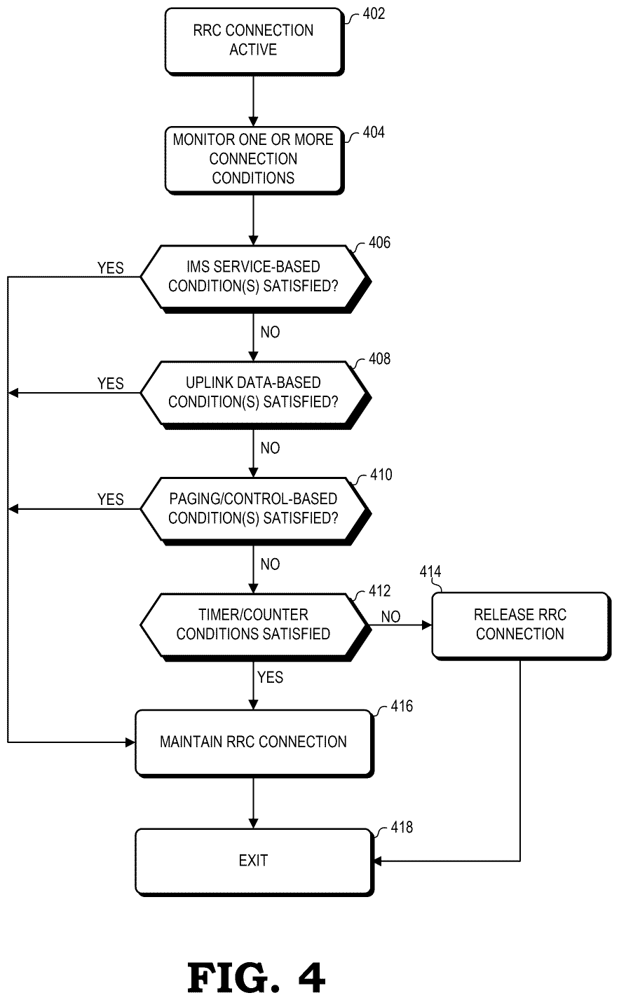

FIG. 4 illustrates a flow diagram of a method 400 for dynamically managing RRC connection release at a UE 102. The processes described below with respect to method 500 are detailed further with reference to FIGS. 1 through 3 above. For purposes of description, the method 400 is described with respect to an example implementation of the UE 102 illustrated in FIG. 1 and FIG. 3, but it will be appreciated that, in other implementations, the method 400 is performed within systems with different configurations of the UE 102. Furthermore, the method 400 is not limited to the sequence of operations shown in FIG. 4, as at least some operations can occur in parallel or in a different sequence. Additionally, in at least some implementations, the method 400 can include one or more different operations beyond those depicted in FIG. 4.

At block 402, the UE 102 begins in a state where the RRC connection is active. This initial state allows the UE 102 to monitor various network and device conditions to determine whether to retain or release the connection. The decision to proceed depends on subsequent evaluations of one or more conditions, such as IMS status, uplink data activity, or paging and control message requirements, as outlined in the various configurations described below.

At block 404, the UE 102 monitors connection-related conditions beyond simple data inactivity, including IMS setup status, uplink data presence, paging, control message requirements, a combination thereof, and the like. At block 406, as part of the monitoring of conditions, the UE 102 evaluates conditions related to IMS services. For example, if the network supports IMS services but the IMS packet data network (PDN) is not yet established, the UE 102 keeps the RRC connection active at block 416 to facilitate the setup process, and further evaluations at subsequent blocks are skipped. The process then exits at block 418. Similarly, if IMS service is supported by the network but not yet registered on the UE 102, the RRC connection is maintained at block 416 to expedite the registration process, and further evaluations at subsequent blocks are skipped. The flow then exits at block 418. If an IMS condition(s) is not met, the UE 102 proceeds to evaluate additional conditions.

At block 408, as part of the monitoring of conditions, the UE 102 monitors uplink (UL) data activity. For example, the UE 102 determines whether there is pending data in the UL buffer. If data from the application processor (e.g., web browsing, DNS queries) or the modem (e.g., Bearer Independent Protocol (BIP) or dummy packets) is queued for transmission, the UE 102 retains the RRC connection at block 416 to ensure timely data transfer, and further evaluations at subsequent blocks are skipped. The flow then exits at block 418. If no pending UL data is detected, the UE 102 proceeds to the next condition evaluation.

At block 410, as part of the monitoring of conditions, the UE 102 evaluates paging and control message requirements. For example, if the UE 102 receives a paging message intended for it, the RRC connection is maintained at block 416 to handle the paging promptly, and further evaluations at subsequent blocks are skipped. The flow then exits at block 418. Additionally, if there are pending control messages, such as those from the NAS, AS, or other layers (e.g., LPP commercial mobile alert system (CMAS)/wireless emergency alerts (WEA), or short message service (SMS)), the UE 102 maintains the RRC connection as active at block 416 to facilitate their transfer, and further evaluations at subsequent blocks are skipped. The flow then exits at block 418. If one, or in at least some embodiments, more than one paging or control message condition is not satisfied, the UE 102 proceeds to block 412 for further evaluation.

At block 412, the UE 102 evaluates the overall need for the RRC connection when none of the immediate conditions evaluated in blocks 406, 408, and 410 are satisfied. This process uses one or more timers, one or more counters, or a combination thereof to refine the decision-making. A timer(s) is initialized to introduce a delay(s), allowing borderline conditions, such as pending IMS setup, uplink data transmission, or control message transfer, to stabilize before a final decision is made. A counter(s) tracks the frequency of events, such as IMS setup retries, uplink transmissions, or paging occurrences, to identify patterns of activity that might justify retaining the connection. For example, if uplink activity occurs sporadically, the counters help determine whether the connection should remain active for expected future activity. This block aggregates and weights inputs from one or more previously monitored conditions.

The UE 102 uses the aggregated data from the timer(s) and/or counter(s) to make a definitive decision on whether to retain or release the RRC connection. The UE 102 applies evaluation logic, combining monitored inputs with predefined thresholds and weighted scoring to prioritize high-value conditions. For instance, conditions, such as IMS setup or control messages, are given higher priority in the decision-making process. If a timer(s) indicates ongoing activity or a counter(s) shows frequent triggers of specific events, the UE 102 retains the RRC connection at block 416 to maintain service continuity. The process then exits at block 418. Conversely, if a threshold(s) is not met, such as a timer expiring or a counter value indicating low activity, the UE 102 proactively releases the RRC connection at block 414 to conserve power and network resources. This process ensures a balanced, data-driven decision that optimizes power efficiency while preserving seamless service continuity when necessary. The flow then exits at block 418.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method at a user equipment (UE) of a cellular network, comprising:
detecting at least one condition of a plurality of conditions associated with a Radio Resource Control (RRC) connection between the UE and the cellular network; and
maintaining the RRC connection in response to the detected at least one condition.

2. The method of claim 1, wherein the maintaining of the RRC connection comprises:
re-establishing the RRC connection in response to the cellular network releasing the RRC connection and the detected at least one condition indicating that the RRC connection is to be maintained.

3. The method of claim 1, wherein the maintaining of the RRC connection comprises:
preventing an RRC release procedure at the UE in response to the detected at least one condition indicating that the RRC connection is to be maintained.

4. The method of claim 1, wherein the maintaining of the RRC connection comprises:
responsive to at least of one or more timers or one or more counters associated with the at least one condition satisfying at least one threshold, maintaining the RRC connection.

5. The method of claim 1, wherein the detecting of the at least one condition comprises:
evaluating at least one condition associated with at least one of one or more paging messages or one or more control message transfers to determine whether the RRC connection is to be maintained.

6. The method of claim 1, wherein detecting the at least one condition comprises:
monitoring at least one of an Internet Protocol Multimedia Subsystem setup or registration status of the UE.

7. The method of claim 1, wherein the detecting of the at least one condition comprises:
determining that an uplink data buffer of the UE comprises data to transfer.

8. A user equipment, comprising:
one or more radio frequency (RF) modems configured to wirelessly communicate with at least one network;
one or more processors coupled to the one or more RF modems; and
at least one memory storing executable instructions, the executable instructions configured to manipulate at least one of the one or more processors or the one or more RF modems to:
detect at least one condition of a plurality of conditions associated with a Radio Resource Control (RRC) connection between the UE and a cellular network; and
maintain the RRC connection in response to the detected at least one condition.

9. The user equipment of claim 8, wherein the at least one of the one or more processors or the one or more RF modems are configured to maintain the RRC connection by:
re-establishing the RRC connection in response to the network releasing the RRC connection and the detected at least one condition indicating that the RRC connection is to be maintained.

10. The user equipment of claim 8, wherein the at least one of the one or more processors or the one or more RF modems are configured to maintain the RRC connection by:
preventing an RRC release procedure at the UE in response to the detected at least one condition indicating that the RRC connection is to be maintained.

11. The user equipment of claim 8, wherein the at least one of the one or more processors or the one or more RF modems are configured to maintain the RRC connection by:
maintaining the RRC connection in response to at least of one or more timers or one or more counters associated with the at least one condition satisfying at least one threshold.

12. The user equipment of claim 8, wherein the at least one of the one or more processors or the one or more RF modems are configured to detect the at least one condition by:
evaluating at least one condition associated with at least one of one or more paging messages or one or more control message transfers to determine whether the RRC connection is to be maintained.

13. The user equipment of claim 8, wherein the at least one of the one or more processors or the one or more RF modems are configured to detect the at least one condition by:
monitoring at least one of an Internet Protocol Multimedia Subsystem setup or registration status of the UE.

14. The user equipment of claim 8, wherein the at least one of the one or more processors or the one or more RF modems are configured to detect the at least one condition by:
determining that an uplink data buffer of the UE comprises data to transfer.

15. A method at a user equipment (UE) of a cellular network, comprising:
monitoring for a plurality of conditions including:
an uplink data buffer at the UE to detect whether data is pending for transmission,
a paging message intended for the UE from the cellular network, and
an Internet Protocol Multimedia Subsystem registration process ongoing at the UE;
maintaining an active Radio Resource Control (RRC) connection between the UE and the cellular network if at least one of the plurality of conditions is satisfied; and
releasing the RRC connection if none of the plurality of conditions are satisfied.
